(19) United States
(12) Patent Application Publication
(10) Pub. No.: US 2007/0110871 A1
(43) Pub. Date: May 17, 2007

(54) Ice cream having improved stability

(75) Inventors: Geertruida Lotte Alida Boterkooper, Den Bosch (NL); Kurt Staas, Sad Schwartau (DE)

Correspondence Address: THE WEBB LAW FIRM, P.C., 700 KOPPERS BUILDING, 436 SEVENTH AVENUE, PITTSBURGH, PA, 15219, US

(73) Assignee: CAMPINA B.V., ZATTBOMMEL (NL)

(21) Appl. No.: 10/574,063

(22) PCT Filed: Oct. 4, 2004
(86) PCT No.: PCT/NL04/00696

§ 371 Date: Nov. 10, 2006

(30) Foreign Application Priority Data
Oct. 2, 2003 (NL) PCT/NL03/00673

(51) Int. Cl. A23G 9/00

(52) U.S. Cl. 426/565

(57) ABSTRACT

The invention relates to ice cream prepared by freezing an ice cream mix having a freezing point of −3.5° C. or lower, comprising at least 0.2% (w/w) unsaturated emulsifier; an ice cream mix having substantially the same composition for preparing the same by e.g. aerating and freezing; and a process for the preparation of the ice cream.

This invention relates to ice cream prepared by freezing an ice cream mix having a freezing point of −3.5° C. or lower, a method for obtaining said ice cream and an ice cream mix for preparing the ice cream.

Ice cream is a well-known food product (see e.g. WO00/01246) which has a smooth and creamy texture. Ice cream is prepared by freezing an emulsion under the incorporation of a gas. The emulsion is also referred to as the “ice cream mix” or “mix”. Said mix is generally composed of fat, milk solids non-fat, sugars, stabilisers, emulsifiers, water and salts.

The term “ice cream” is well known in the art and is obtained by freezing the ice cream mix upon whipping. As such, the ice cream has the same composition as the mix; however, its structure differs as ice cream is (at least partially) frozen and a substantial portion of the ice cream's volume is made up of air.

The unique structure of the ice cream is due to a complex interplay between the mix components. In the mix, the fat exists as tiny globules, that are formed by homogenisation. Those fat globules are coated by a protein layer to form an oil-in-water emulsion. The protein thus stabilises the fat globules in the water phase. In ice cream, those fat globules need however to be destabilised as to form a partially coalesced network surrounding and stabilising the air bubbles that are incorporated in the ice cream upon whipping of the mix (This process is called “churning”). To this end, emulsifiers, i.e both saturated and unsaturated emulsifiers, are added to the mix to reduce the stability of the mix emulsion and to increase the churnability thereof. See e.g. U.S. Pat. No. 6,497,913. Also, in reduced fat (1-9% w/w) ice cream, emulsifiers help to stabilise the foamed emulsion (before and after freezing). The emulsifier displaces proteins on the surface of the fat globules, which process is also known as “ripening” of the emulsion, to interrupt the regularity of this protein layer. As a consequence of this destabilisation, upon whipping the fat globules will partially coalesce and, during the freezing process, form a network to stabilise the thus incorporated air bubbles (forming air cells). The fat and air cell structure are essential to confer ice cream its typical sensation.

The water present in the frozen ice cream is present both in frozen and unfrozen state; thus, the ice cream comprises both a frozen and an unfrozen water fraction. The frozen water fraction is constituted by ice crystals, which are in addition to the above-discussed fat and air cell structure, important for the unique “icy” texture of the ice cream. However, too many and/or too large ice crystals in the ice cream can also negatively affect the ice cream texture and smoothness, resulting in an undesired gritty, coarse icy sensation.

The unfrozen water fraction accommodates the water soluble ingredients of the ice cream. This fraction is commonly known as the aqueous phase. The said aqueous phase plays an important role in the stabilisation of the required foamy air cell structure of the ice cream and the scoopability thereof. During freezing, ice crystals are formed such that less unfrozen water becomes available, resulting in concentration of the water soluble ingredients in the aqueous phase. Thus, an increase in viscosity of the aqueous phase is obtained, which viscosity increase plays an important role in inhibiting the disproportionation of the foam structure. The rigidity of the matrix inhibits the coalescence of the air cells.

Thus, by freezing the ice cream, ice crystals are formed and the viscosity of the aqueous phase increases. However, by the freezing process the number and size of the ice crystals increase, which, as outlined above, can also have a negative effect on the texture and smoothness of the ice cream. Thus, a delicate balance exists between the structural stability imparted by the viscosity of the aqueous phase, and the texture and taste sensation conferred to the ice cream by ice crystals.

It has long been known that ice cream having fewer and/or smaller ice crystals, herein also referred to as “less ice”, tastes smoother and creamier, and less gritty and coarse. In order to obtain ice cream of such quality, it has been attempted in the art to lower the freezing point of the mix (to e.g. −3.5° C. or lower), which results in formation of less ice in the ice cream, and thus an improved smooth and creamy taste in comparison to conventional ice cream having a freezing point of about −2.5° C. The term “freezing point” as used herein refers to the freezing temperature at which the ice cream mix starts to freeze. In the art, it is known that a freezing point depression in ice cream mix may be accomplished by altering, for example, the sugar and/or salt composition/concentration in the ice cream mix. Conventionally, the freezing point of ice cream is about −2.5° C. Methods for determining the freezing point of ice cream mix are known in the art. The freezing point may for example be measured using any instrument capable of determining the freezing point of liquid, such as e.g. the Advanced milkcryoscope type 4D3 (Labyrint Holland BV, The Netherlands) according to the instructions of the manufacturer.

However, as outlined above, the presence of sufficient ice is important to have sufficient viscosity of the unfrozen aqueous phase for stabilising the air cells. As a consequence of a decreased freezing point, i.e. the presence of less ice, such ice cream often suffers from lack of air cell (foam) stability. This reduced air cell stability results for example in rapid coarsening (disproportionation and/or coalescence) of air cells during storage at a temperature below −15° C., which causes a major texture deterioration in the ice cream. After only few weeks of storage, large air cells are found to be present in the ice cream with a depressed freezing point, which renders such ice cream unattractive; mouthfeel and scoopability are affected. Thus, ice cream having a depressed freezing point of −3.5° C. or lower may have an improved texture because of less and/or smaller ice crystals, but is impaired in stability of air cells.

In an attempt to counteract this structural deterioration due to lack of air cell stability associated with ice cream prepared from a mix having a decreased freezing point, in the art high concentrations of stabilisers, such as e.g. locust bean gum, guar gum, carrageenan, microcrystalline cellulose, carboxymethylcellulose, pectin, gelatin, gum arabic, gellan gum, xanthan gum, modified starch, or a combination of two or more thereof, are used to bind unfrozen water in order to obtain a stable air cell (“foam”) structure. However, the addition of high concentrations of stabilisers confers the ice cream a thready, gummy/rubbery and chewy mouthfeel, which is judged unpleasant. Moreover, the addition of high levels of stabilisers causes an increase in the viscosity of the ice cream mix, thus resulting in cumbersome processing and increased energy costs. It has not been possible to combine the improved taste of ice cream with a decreased freezing point with sufficient stability of the air cells. In the art, no satisfying solutions to the stability problems of ice cream with a decreased freezing point are known.

Therefore, it is an object of the present invention to provide ice cream prepared from ice cream mix having a depressed freezing point of −3.5° C. or lower, which still possesses a highly stable structure with a creamy and smooth, rather than thready and chewy texture. A “stable structure” or “air cell stability” is to be understood in such a way that at least no substantial coarsening of the air cells takes place during a frozen storage period at a temperature below −15° C. of at least 2, 3, 4, 6, 8 weeks, more preferably at least 4, 6, 10 months, and most preferably at least 12 months. This means that in ice cream according to the invention, no substantial coarsening of air cells is observed even after a period of 12 months of storage.

Surprisingly, it was found that such a smooth and creamy tasting, highly stable ice cream was obtained by incorporating a high content of unsaturated emulsifier to ice cream prepared from a mix with a freezing point of −3.5° C. or lower. It was found that the unsaturated emulsifier did not have any unpleasant effect on taste and texture of the ice cream. Faced with the problems, encountered when making ice cream having a low freezing point, the skilled person would never contemplate to incorporate unsaturated emulsifier, as known in the field of ice cream preparation, this compound never has been associated with a stabilising function of air bubbles in frozen confection. Certainly one reason not to include an increased level of unsaturated emulsifier is the risk of off-taste, which may arise due to oxidation of the unsaturated fatty-acid chains in the emulsifier.

So the invention is substantially to be seen in the fact that instead of using water binding stabilisers to stabilise air bubbles in low freezing point ice cream, the use of unsaturated emulsifier, in particular unsaturated mono- and diglycerides, preferably unsaturated monoglycerides, results in a sufficient stabilising effect for low freezing point ice cream.

Examples of such water binding stabilisers used in the art for the above aim are guar gum, locust bean gum, carrageenan (lambda-, iota-, kappa- or mixtures thereof), microcrystalline cellulose, carboxymethylcellulose, pectin, gelatine, gum arabic, gellan gum, xanthan gum, modified starch, (sodium)alginate or a combination thereof.

As outlined above for the preparation of an ice cream mix of low freezing point, the skilled person would, if he would start from an ice cream mix of low freezing point, add freezing point lowering ingredients as sugars, and, simultaneously, add water binding stabilisers which leads to texture impairment. He would not be aware of the fact that unsaturated emulsifier already have the required stabilising effect (without impairment of texture, taste, etc. in a rather high content of above 0.2 w/w %.

As such, the use of unsaturated emulsifier in high freezing point ice cream is known from both patent and scientific literature, see e.g. U.S. Pat. No. 4,127,679, U.S. Pat. No. 6,497,913, EP 1,348,341, U.S. Pat. No. 6,596,333, U.S. Pat. No. 3,017,76, U.S. Pat. No. 2,423,600, US 2003/0134025, JP 2000-270777, JP 54-55762, Cho, Y.-K., Korean J. Food Sci. Technol. Vol. 20, no. 2, 1988, pp. 236-244, and Pelan, B. M. C. et al., J. Dairy Sci. Vol. 80, no. 10,1997, pp. 2631-2638. The said emulsifier is incorporated to achieve a required churning effect.

The above is even more surprising, as the skilled person would look for water binding compounds to include in the ice mix to stabilise low freezing point ice cream, whereas it is known that unsaturated emulsifiers tend to dissolve in the fatty phase of the emulsion, which would in conventional thinking not contribute to the stability of the ice cream air bubbles!

As outlined above, the unsaturated emulsifier is incorporated in the ice cream only to destabilise the fat globules in the ice cream. No stabilising effect with regard to air cell stability has been described thus far.

Thus, the present invention in first instance relates to ice cream prepared by freezing an ice cream mix having a freezing point of −3.5° C. or lower, comprising at least 0.2% (w/w) unsaturated emulsifier.

The term “unsaturated emulsifier” is well known in the art. Such emulsifiers are derived from unsaturated fats and generally constitute a mixture of mono- and diglyceride esters of unsaturated fatty acids with glycerol, also referred to as mono- and diglycerides, respectively. Examples of commercially available unsaturated emulsifier preparations are e.g. the emulsifiers Dimodan RT, P Bel B, U/J, UP/B, S, OT Pel and LS of Danisco, Denmark, Grindsted PS 217/B, Grindsted Mono Di SL60 of Danisco, Denmark, Palsgaard, 0094, 0095, 0098 and 0291 of Palsgaard, Denmark and Myverol 18-35K, 18-92K and 18-50XL PL of Quest, The Netherlands, or combinations of two or more thereof. Generally, such commercial unsaturated emulsifier preparations may also comprise substantial amounts of other substances, but usually at least 50% (w/w) of the preparations are composed of unsaturated emulsifier, but higher amounts are also common. It is to be understood that in case an unsaturated emulsifier preparation comprising 50% (w/w) unsaturated emulsifier is used in the ice cream according to the present invention, preferably at least 0.4% (wlw) of the unsaturated emulsifier preparation is incorporated in the ice cream mix. According to the invention, both cis- and trans-unsaturated emulsifiers, or a combination thereof can be used. It is preferred that the mix is void of saturated emulsifiers; however, saturated emulsifiers as well as any other emulsifiers commonly known in the art may be present. The amount of unsaturated emulsifier in the ice cream mix can be determined using any conventional method or methods, such as e.g. gas liquid chromatography (GLC), optionally using a combination of conventional methods, such as e.g. GLC with any additional conventional method for quantitation of such unsaturated emulsifier, such as mass spectrometry.

It has surprisingly been found that incorporation of unsaturated emulsifier in the amounts as defined by the present invention, conferred the low freezing point (with a freezing point of −3.5° C. or lower) ice cream exceptional stability with regard to resistance to coarsening of air cells, which is especially important in ice cream having a decreased freezing point, i.e. having less ice as compared to high freezing point ice cream. As outlined above, high freezing point ice cream in this respect is ice cream having a freezing point of not lower than about −2.5° C. It was not known in the art that unsaturated emulsifiers not only function to destabilise fat globules in the mix, but also aid to stabilise air cells in the ice cream when present in the amount, as is described above. The invention therefore also relates to the use of unsaturated emulsifier to stabilise air cells in aerated desserts, in particular ice cream, ore in particular ice cream having a freezing point of −3.5° C. or lower, which will be further outlined below.

Surprisingly, the ice cream was also found to be exceptionally stable to temperature fluctuations. This is especially important as temperature fluctuations result in significant coarsening of air cells and growth of ice crystals, which processes make the ice cream feel more icy and less creamy. Thus, generally temperature fluctuations result in ice cream with a deteriorated texture sensation. Such temperature fluctuations occur e.g. during transportation, storage at the grocery store or during transportation and storage by the consumer.

A third interesting aspect of the ice cream according to the invention is that it was found to be highly shape stable, i.e. at room temperature melting was retarded in comparison to conventional ice cream. The latter makes the ice cream according to the present invention particularly suitable for frozen ice cream patisserie, such as e.g. ice pudding or ice cream cake.

According to the invention, it is found that high contents of the unsaturated emulsifier in combination with the lowered freezing point provides ice cream with less ice and relatively small air bubbles, which synergistically results in soft, creamy and smooth tasting ice cream which is not only structurally highly stable, but also highly shape stable. Without being bound to any explanation, it is thought that the high content of unsaturated emulsifier prevents the coalescence and/or disproportionation of small air bubbles into larger air bubbles, such that the ice cream structure remains very fine and highly (shape) stable.

It is preferred that the ice cream mix has a freezing point of −4° C. or lower, more preferably −4.5° C., or lower, as again less ice is formed and the ice cream sensation is even more creamy.

The content of stabilisers can be kept at a conventional or even lower level, i.e. the normal/lower content of stabilisers in conventional ice cream having been prepared from an ice cream mix with a conventional freezing point of about −2.5° C.

In a preferred embodiment, the ice cream comprises at least 0.25% (w/w), more preferably at least 0.3% (w/w) unsaturated emulsifier. In this range, the best results are obtained for taste, structural stability, i.e. air cell stability, ice crystal stabilisation and immobilisation of the unfrozen water, as well as shape stability. It is preferred that the ice cream comprises at most 1%, preferably at most 0.75, more preferably at most 0.5 (w/w) unsaturated emulsifier.

It is preferred that the unsaturated emulsifier comprises unsaturated glyceride, preferably unsaturated monoglyceride, diglyceride or mixtures thereof. Non-limiting examples of the unsaturated emulsifier which may be suitable for the present invention are disclosed above. The skilled person will be aware of suitable unsaturated emulsifier for the envisaged aim.

In a preferred embodiment, the unsaturated emulsifier of the ice cream according to the invention comprises, on weight basis, at least 50% unsaturated monoglyceride, preferably at least 60%, more preferably at least 80%, even more preferably at least 90% and most preferably 100% unsaturated monoglyceride. In another embodiment, it is preferred that the amount (on weight basis) of unsaturated emulsifier calculated on the total weight of emulsifier in the ice cream or ice cream mix, is more than 20 w/w %, preferably more than 25, 40, 60, 80 w/w %, and most preferably more than 95 w/w %.

In a further embodiment the invention relates to ice cream as disclosed above, preferably comprising 5-30% (w/w) sugar, the sugar being selected as to achieve a freezing point of the ice cream mix of −3.5° C., preferably −4° C., more preferably −4.5° C. or lower. It is known in the art how such freezing point can be achieved, and a skilled practitioner will readily be able to select suitable sugar sources and combinations thereof with suitable salts as to achieve such freezing point.

Sugar (which is herein meant to include all carbohydrates) and/or salt improve texture and palatability of the ice cream and enhance flavours. Moreover, sugar and salt play an essential role in depression of the freezing point so that the ice cream comprises the required unfrozen water at very low temperatures typical of the serving temperature, such as −15° C. Without sufficient unfrozen water, the ice cream would be too hard and icy to taste pleasant.

The term “sugar” is well known in the art and refers to any conventionally used carbohydrates, sugars, sweeteners or combinations thereof. Non-limiting examples of sugar are sucrose, maltose, lactose, invert sugar, glucose, galactose, dextrose, fructose, sorbose and xylose, and sugar alcohols, such as mannitol, xylitol and lactitol, or combinations thereof. The sugar may also be provided in the form of sweeteners derived from e.g. corn syrup, starch syrup, whey syrup, glucose syrup, etc., or in the form of hydrolysates of well-known carbohydrates, disaccharides, trisaccharides, tetrasaccharides, etc, or combinations of one or more thereof. One skilled in the art will easily be able to determine which sugar, syrups or hydrolysates, as well as the content thereof, will be suitable to obtain the desired freezing point, optionally in combination with a suitable selection of salt.

In a further embodiment, the present invention relates to ice cream according to the present invention, wherein the sugar comprises at least 50% (w/w) monosaccharides. This means that of the total amount of sugar on weight basis, at least 50% (w/w) are monosaccharides, such as e.g. dextrose, glucose, galactose, fructose, sorbose and xylose, or combinations of two or more thereof. Such content of monosaccharides is generally sufficient to obtain the desired freezing point depression to −3.5° C. or lower, preferably −4° C. or lower, more preferably −4.5° C. or lower.

It is preferred that the sugar is chosen from the group, consisting of lactose, sucrose, galactose, glucose, glucose syrup and dextrose or a combination of two or more thereof. It has been found that excellent ice cream was obtained using such sugar composition.

In a further embodiment, the ice cream according to the invention further comprises 1-18% (w/w) fat, 4-16% (w/w) milk solids non-fat and 0.1-0.5%, preferably 0.2-0.4, and most preferably 0.3% (w/w) stabilisers. With such composition, highly stable ice cream is formed which has a smooth and creamy taste. The term “fat” may be any type of fat, and includes e.g. vegetable fat, milk fat or combinations thereof. Non-limiting examples of milk fat are e.g. butter, cream, butter concentrate, butter oil and fractionated butter. Vegetable fat can e.g. be palm fat, palm kernel fat, coconut fat, or combination of two or more thereof, and may be of natural origin (non-hardened), or (partially) hardened.

Preferably, the fat in ice cream according to the invention is, on weight basis, at least 50%, preferably at least 60%, more preferably at least 75% and most preferably 100% of the fat in the ice cream is vegetable fat. The vegetable fat is preferably palm kernel fat or coconut fat or a combination thereof, preferably (partially) hardened. The ratio between palm kernel fat and coconut fat is preferably 0:100-100:0, more preferably 20:80-80:20, even more preferably 40:60-60:40, and most preferably 50:50.

The term “milk solids non-fat” is well known in the art and refers to milk components, which are preferably dried, and from which the major part of the milk fat has been removed. The milk solids non-fat may (partially) consist of whey protein preparations, such as e.g. whey protein concentrates or isolates. Other non-limiting examples of milk solids non-fat are skim milk powder, yogurt or yoghurt powder (for yoghurt ice) caseinates (Na, K, Ca), milk protein concentrate (MPC) or mixtures of two or more thereof.

Ice cream according to the invention can comprise common water binding stabilisers as described above. However, as discussed above, the amount thereof can be limited, as the unsaturated emulsifier provides for the required stabilising effect. Preferably, the ice cream according to the invention comprises less than 0.5 w/w % stabilisers, preferably in the range of 0.05-0.50, more preferably 0.10-0.40 and most preferably 0.15-0.25 w/w %. The stabilisers used are common in the art (e.g. for their water binding capacities) but are usually selected from guar gum, locust bean gum, carrageenan (lambda-, iota-, kappa- or mixtures thereof), microcrystalline cellulose, carboxymethylcellulose, pectin, gelatine, gum arabic, gellan gum, xanthan gum, modified starch, (sodium)alginate or a combination thereof.

Preferably used in the ice cream according to the invention are guar, locust bean gum and carrageenan. Preferable concentration ranges are (w/w) 0.01-0.15%, pref. 0.05-0.10% most preferred 0.06-0.08% for guar gum; 0.01-0.15%, pref. 0.05-0.10%, most pref. 0.06-0.08% for locust bean gum; and 0.01-0.10%, pref. 0.02-0.07%, most preferred 0.03-0.06% for carrageenan.

Another embodiment of the invention concerns an ice cream according to the invention, comprising 5-10% (w/w) of a hydrolysed lactose preparation, 2-8% (w/w) sucrose and 10-22% (w/w) dextrose. The hydrolysed lactose preparation may be completely or partially hydrolysed. It has been found that using such relatively cheap sugar source, an excellent highly stable ice cream was obtained which was very resistant to temperature fluctuations also highly shape stable.

Due to its soft Theological properties, the ice cream according to the present invention is highly suitable for packaging in a squeezable container, such as e.g. a tube or pouch. Thus, in a further embodiment the invention relates to an ice cream according to the present invention, characterised in that it is packaged in a squeezable container, such as e.g. a tube or a pouch. Said container is designed as to squeeze the ice cream from an opening, for example directly into the mouth, and may optionally be fitted with a closable lid, such as e.g. a spout with a lid.

In a very attractive embodiment, the ice cream mix according to the invention is packaged in an aerosol. Preferably, the ice cream mix is aerated, or whipped, before dispensing from the aerosol, e.g. before or during filling of the ice cream mix in the aerosol. This means that the ice cream is already sufficiently aerated within the aerosol so that no overrun (i.e. volume increase upon dispersing from the aerosol) takes place. However, it is very well possible to incorporate a propellant in the ice cream mix in the aerosol, resulting in aeration, or whipping of the ice cream upon dispersing from the aerosol.

Suitable propellants known in the art, e.g. nitrogen, nitrous oxide, carbon dioxide, air and mixtures thereof, in particular mixtures of nitrogen and nitrous oxide. The skilled person is aware of the proper aerosol can design and applied pressure, sufficient to dispense the ice cream at the required temperature.

In a preferred embodiment, the aerosol comprises a piston, driven by propellant. Such aerosol “piston” cans may be obtained from CCL Industries, Canada. Alternatively, a similar aerosol system can be used as described in EP 816 254.

In a further aspect the invention relates to ice cream mix having a freezing point of −3.5° C. or lower, comprising at least 0.2% (w/w) unsaturated emulsifier. As indicated above, such ice cream mix has substantially the same composition as the ice cream. The mix is aerated and frozen, e.g. as described below, to obtain the ice cream. The ice cream mix may also be provided as a concentrate of its components which may be diluted with e.g. water or milk as to obtain the mix. Alternatively, the ice cream mix may be provided as a kit comprising ice cream ingredients as separate components, which may e.g. be mixed with water or milk to obtain the ice cream mix.

Preferably, the ice cream mix according to the invention comprises at least 0.25% (w/w) unsaturated emulsifier. It was found that using such content of unsaturated emulsifier provided the best results with regard to air cell stability, taste, shape stability and resistance to temperature fluctuations (so-called improved “heat-shock stability”).

In a further embodiment the ice cream mix according to the invention further comprises fat, milk solids non-fat, sugar and stabiliser as described above as to prepare the ice cream according to the invention.

It is preferred that the ice cream mix according to the invention has a freezing point of −4° C. or lower, and it is even more preferred that it has a freezing point of −4.5° C. or lower, as the most creamy ice cream is thus obtained.

In addition, the present invention relates to a blend for preparing ice cream according to the present invention comprising unsaturated emulsifier, fat, sugar, stabilisers and milk solids non-fat. It is advantageous that the unsaturated emulsifier is incorporated in such a blend, as the otherwise solid emulsifier is then solubilised as to facilitate handling thereof and incorporation in the mix. Moreover, it is advantageous to have the stabilisers incorporated as to reduce the amount of processing steps to obtain the ice cream mix. The blend of the invention is mixed with the remaining mix components as to obtain the ice cream mix according to the invention. It is preferred that the blend is a dry composition, however this is not required.

In one embodiment, the blend comprises 5-50% (w/w) unsaturated emulsifier, 5-60% (w/w) fat, 7-15% (w/w) sugar, 3-30% (w/w) stabilisers and 2-5% (w/w) milk solids non-fat. Preferably, the blend comprises 7-40% (w/w) unsaturated emulsifier and 7-40% (w/w) fat. More preferably, the blend comprises 10-35% (w/w) unsaturated emulsifier and 10-35% (w/w) fat. Using such amount of ingredients, a blend is obtained which has excellent properties with regard to incorporation and solubilisation of the emulsifier and incorporation of stabiliser. The above blend can be mixed with the remaining amounts of e.g. fat, milk solids non-fat, sugar, water and optionally stabilisers and other ingredients, such as e.g. salt, necessary to obtain the ice cream mix according to the present invention.

As outlined above, the present invention relates to the use of the above blend for preparing ice cream according to the invention. As such, it is preferred that 1-2% (w/w), preferably 1.2-1.6% (w/w), more preferably about 1.4% of the blend is incorporated in the ice cream mix as to obtain the desired concentration unsaturated emulsifier in the mix.

Generally, ice cream manufacturing comprises the steps of preparing an ice cream mix, ripening/ageing said mix, whipping and (partially) freezing said mix, optionally hardening the thus formed ice cream, followed by storage at a temperature of less than −15° C. The mix is often prepared by blending of the ingredients to form a mix, pasteurisation, homogenisation and ageing of the mix. Following mix processing, the mix is optionally drawn into a flavour tank where any liquid flavours, fruit purees or colours are added. The ice cream mix may then enter a dynamic freezing process which both freezes a portion of the water and whips air into the frozen mix. The mix is pumped through the freezer at sub-zero and is mostly drawn off the other end with about 40% of its water frozen. Subsequently, particulates, such as fruits, nuts, cookies, candy, etc., may be added to the semi-frozen ice cream and the ice cream is placed into a blast freezer where most of the remaining water is frozen. The manufacture of ice cream is well known in the art. It is to be understood that any process for preparing ice cream according to the present invention may be employed.

Generally, the dynamic freezing process, i.e. the freezing with incorporation of air, is carried out at a so-called drawing temperature of −5/−6° C. However, at such temperature the ice cream according to the present invention is not formed, as no stable ice crystals are formed.

Therefore in a further aspect the invention relates to a process for the preparation of an ice cream according to the present invention comprising the steps of: a) preparing an ice cream mix according to the invention; b) aerating and freezing the mix at a drawing temperature in the range of −8° C. to −12° C.; and c) hardening the ice cream at a temperature in the range of −20° C. to −50° C. It was found that at a drawing temperature in the range of −8° C. to −12° C. sufficient ice is formed to stabilise the foam network, and the ice cream has a good scoopability and soft, warm and smooth taste at a typical serving temperature of −15° C. to −20° C.

“Drawing temperature” as herein used refers to the temperature of the ice cream at the exit of the freezer. According to the present invention the ice cream mix may be first aerated and then frozen, may be first partially frozen and then aerated, or the aeration and freezing may take place simultaneously, or a combination of these steps.

Preferably, in step a) an ice cream mix is prepared by combining a water phase and a fat phase, the emulsifier at least partially being incorporated in the fat phase. In this manner, the emulsifier is best incorporated in the ice cream structure, and the ice cream structure is most stable.

According to the invention, it was found for the first time that unsaturated emulsifier could be employed for preventing air cell coarsening in aerated frozen desserts, in particular ice cream, more in particular ice cream having a freezing point of −3.5° C. or lower.

Therefore, in a further aspect the invention relates to the use of unsaturated emulsifier for preventing air cell coarsening in an aerated frozen dessert. Herein, the term “air cell coarsening” refers to the coalescence and disproportionation of air cells as is discussed above. Such a dessert is generally prepared by aerating and freezing an dessert mix, such as e.g. ice cream mix, ice milk mix, frozen yoghurt mix, fruit juice mix, etc. Non-limiting examples of such aerated frozen desserts are ice cream, ice cream prepared from a mix having a depressed freezing point, in particular of −3.5° C. or lower, ice milk desserts, frozen yoghurt desserts, frozen fruit juice desserts, etc. The unsaturated emulsifier is thus incorporated to stabilise the air cell structure in said aerated frozen dessert. It is preferred that the unsaturated emulsifier is present in an amount of at least 0.2% (w/w), preferably at least 0.25% (w/w) in the dessert, as it was found that the prevention of air cell coarsening was particularly well at such content of unsaturated emulsifier. In particular, the present invention relates to the use of the unsaturated emulsifier for stabilising air cells in the dessert for at least 12 months at a storage temperature of −15 to −30° C. Herein, “stabilising air cells” refers to the prevention of air cell coarsening.

In an advantageous embodiment of the above use, the dessert is ice cream having a freezing point of −3.5° C. or lower. Such prevention of air cell coarsening and thus stabilisation of air cells was found to be particularly important and particularly well in such dessert.

### EXAMPLES

The invention is now further illustrated by the following non-limiting examples. Percentages given are weght percentages, unless indicated otherwise.

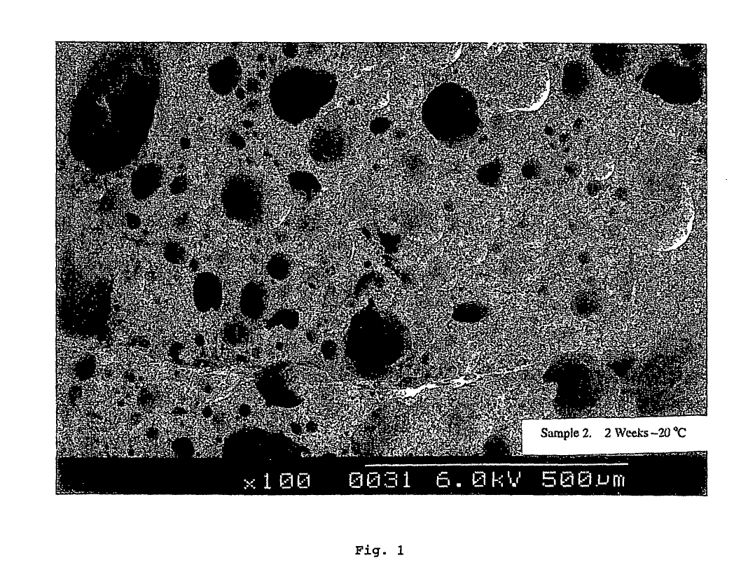

FIG. 1 shows a cryo-SEM micrograph of reference ice cream prepared from a mix with a depressed freezing point and a conventional amount of unsaturated emulsifier after 8 weeks storage at −20° C.

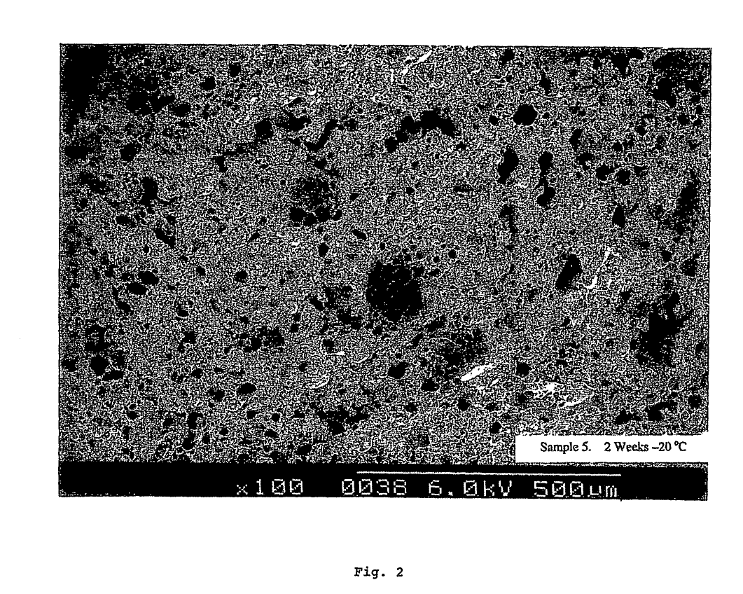

FIG. 2 shows a cryo-SEM micrograph of ice cream according to the present invention after 8 weeks storage at −20° C.

### Example 1

### Preparation of Ice Cream According to the Invention and Comparison with Ice Cream Having a Commonly Used Amount of Unsaturated Emulsifier

Ice cream mix was prepared from 4.0% (by weight) hardened palm kernel fat (Unimills, The Netherlands), 6.2% or 6.0% (depending on the amount of unsaturated emulsifier incorporated; the total amount of fat was the same in both ice creams) hardened coconut fat (Unimills, The Netherlands), 5.0% skim milk powder, 7.1% Esprion 400L (DMV International, The Netherlands; whey product in which the lactose has been partially hydrolysed to glucose and galactose), 17.0% dextrose, 4.0% sucrose and 0.2% (conventional ice cream; A) or 0.4% (ice cream according to the invention; B) unsaturated emulsifier preparation Myverol 18-35K (a preparation comprising about 50% (w/w) unsaturated emulsifier, Quest International, The Netherlands).

The skim milk powder, sugars and Esprion 400L were blended in water of 40° C. to form a water phase. The emulsifier and fat were added to the water phase. The thus formed mix was pasteurised for 10 sec. at 82° C., and then homogenised at 160 bar at 75-80° C. The mix was then cooled to 4° C. and left overnight at 4° C. for ripening. Subsequently, ice cream was produced from the mix using the APV Technohoy MF50 with an overrun of 100% and a drawing temperature of −10/−11° C. Next, the ice cream was hardened at −50° C. for 24 hrs and stored at −20° C.

After 8 weeks of storage at −20° C., both the conventional ice cream (A) and the ice cream according to the present invention (B) were analysed for air cell size, scoopability and shape stability.

To analyse the air cells of both ice creams, cryo-SEM micrographs of the ice cream samples were made (FIGS. 1 (ice cream A) and 2 (ice cream B)). It was found that in ice cream A (FIG. 1) significant coarsening of the air cells had occurred in comparison with freshly prepared ice cream. In contrast therewith, in ice cream B (FIG. 2) the air cell size was comparable to the air cell size of freshly prepared ice cream, and hardly any coarsening had occurred. It was found that this effect was maintained up until at least 12 months of storage at −20° C., whereas the structure of the conventional ice cream A deteriorated even more in the course of time.

In addition thereto, it was found that the ice cream according to the present invention (B) remained easy to scoop, similarly to freshly prepared ice cream, whereas conventional ice cream (A) became much harder to scoop during the prolonged storage time.

Also, both ice creams A and B were exposed to room temperature for 90 minutes, and the serum loss of both ice creams was measured to determine shape stability. The conventional ice cream A appeared to be completely melted after 90 minutes, with a serum loss of 6.7%, whereas the ice cream according to the invention (B) retained its shape, with a serum loss of only 0.9% after 90 minutes of exposure to room temperature.

### Example 2

### Comparison of Ice Cream According to the Invention With Ice Cream Wherein High Amounts of Stabilisers are Employed for Stabilisation of the Air Cell Structure

Ice cream was prepared comprising either 0.3% saturated emulsifier/0.7% (w/w) stabilisers (ice cream C) or 0.5% (w/w) unsaturated emulsifier preparation/0.3% (w/w) stabilisers (ice cream D) respectively. The ice cream was prepared as above in example 1, with the following ingredients (by weight percentage in composition):

| Ingredients (by weight % in composition) | C | D |
|---|---|---|
| Hardened palm kernel fat (Unimills, The Netherlands) | 4.0 | 4.0 |
| Hardened coconut fat (Unimills, The Netherlands) | 6.4 | 6.4 |
| Skim milk powder | 7.0 | 7.0 |
| Esprion 400L (DMV International, The Netherlands) | 7.14 | 7.14 |
| Dextrose | 12.0 | 12.0 |
| Sucrose | 5.0 | 5.0 |
| Glucodry 330 (AVEBE, The Netherlands) | 4.0 | 4.0 |
| Unsaturated emulsifier preparation Myverol 18-35K, | | 0.5 |
| comprising about 50 w/w % unsaturated and about 50 | | |
| w/w % saturated emulsifier (Quest International, | | |
| The Netherlands) | | |
| Emulsifier Cremodan super (Danisco, Denmark) | 0.3 | |
| Guar Meyprogat 150 (Meypro BV, The Netherlands) | 0.35 | 0.2 |
| Locust bean gum Meyprofleur M175 (Meypro BV, The | 0.3 | 0.1 |
| Netherlands) | | |
| Carrageenan Grindsted CL110 (Danisco, Denmark) | 0.05 | |

The ice cream thus prepared was stored at −20° C. for 16 weeks, and was then evaluated sensorially. Ice cream C was judged as follows: a soft scoopable ice cream, moderate in warmth, gummy/rubbery, slimy texture, stringy, slight coarsening of the foam visible, “dusty cardboard” aftertaste. In contrast therewith, the ice cream according to the present invention (ice cream D) was judged as follows: soft scoopable ice cream, warm, creamy, clean eating, no visible coarsening of the foam, no chewy (rubbery) texture, smooth. The taste, texture and mouth feel of the ice cream according to the present invention (D) was thus found considerably more pleasant than the ice cream with a relatively high content of stabiliser (C).

### Example 3

### Comparison of “High Freezing Point Ice Cream” vs. Ice Cream With an Increased Level of Unsaturated Emulsifier According to the Invention

| Ingredients (by weight % in composition) | E | F |
|---|---|---|
| Hardened palmkernel fat (Unimills, The Netherlands) | 4.0 | 4.0 |
| Hardened coconut fat (Unimills, The Netherlands) | 6.4 | 6.4 |
| Skim milk powder | 9.25 | 7.0 |
| Esprion 400L (DMV International, The Netherlands) | | 7.0 |
| Dextrose | | 12.0 |
| Sucrose | 10.0 | 5.0 |
| Glucodry 330 (AVEBE, The Netherlands) | | 4.0 |
| Unsaturated emulsifier preparation Myverol 18-92, | | 0.4 |
| Quest International, The Netherlands | | |
| Cremodan Super Monodiglyceride, Danisco, Denmark | 0.5 | 0.2 |
| Guar Meyprogat 150 (Meypro BV, The Netherlands) | 0.35 | 0.1 |
| Locustbeangum Meyprofleur M175 (Meypro BV, The | 0.35 | 0.1 |
| Netherlands) | | |
| Carrageenan Grindsted CL110 (Danisco, Denmark) | 0.05 | 0.03 |

The content of unsaturated emulsifier in Myverol 18-92 K is approx. 88% w/w. Therefore, the amount of unsaturated emulsifier on the total amount emulsifier is approximately 58%. The amount of unsaturated emulsifier in F (invention) is approx. 0.35%.

In E, the amount of unsaturated Emulsifier is practically zero. It was found that upon storage at −18° for a period of 12 months, the ice cream according to the invention (F) was still easily scoopable, had a smooth and creamy mouth feel and “warm” eating qualities.

The ice cream prepared according the a regular “high freezing point” recipe (E) was after a similar storage time and—temperature, hard, had a cold and icy mouth feel, and was very difficult to scoop; moreover the mouth feel (creaminess) was inferior compared to F.

1-44. (canceled)

45. An ice cream having improved stability, wherein the ice cream is prepared by freezing an ice cream mix having a freezing point of −3.5° C. or lower and comprises at least 0.2% (w/w) unsaturated emulsifier.

46. The ice cream according to claim 45, comprising at least 0.25% (w/w) unsaturated emulsifier.

47. The ice cream according to claim 46, comprising at least 0.3% (w/w) unsaturated emulsifier.

48. The ice cream according to claim 45, comprising at most 1.0% (w/w) unsaturated emulsifier.

49. The ice cream according to claim 48, comprising at most 0.75% (w/w) unsaturated emulsifier.

50. The ice cream according to claim 49, comprising at most 0.5% (w/w) unsaturated emulsifier.

51. The ice cream according to claim 45, wherein the unsaturated emulsifier comprises unsaturated glycerides, such as unsaturated monoglycerides, diglycerides or mixtures thereof.

52. The ice cream according to claim 51, wherein the unsaturated emulsifier comprises, on weight basis, at least 50%, such as at least 60%, such as at least 80%, such as at least 90% and such as 100% unsaturated monoglyderides.

53. The ice cream according to claim 45, wherein the amount, on weight basis, of unsaturated emulsifier calculated on the total weight of emulsifier in the ice cream, is more than 20 w/w %, such as more than 25, 40, 60, 80 w/w %, and such as 95 w/w %.

54. The ice cream according to claim 45, comprising 5-30% (w/w) sugar, the sugar being selected as to achieve a freezing point of the ice cream mix of −3.5° C. or lower.

55. The ice cream according to claim 54, wherein the sugar comprises at least 50% (w/w) monosaccharides.

56. The ice cream according to claim 54, wherein the sugar is selected from the group consisting of lactose, sucrose, galactose, glucose, glucose syrup and dextrose, or a combination of two or more thereof.

57. The ice cream according to claim 45, comprising 1-18% (w/w) fat, 4-16% (w/w) milk solids non-fat and 0.1-0.5% (w/w) stabilizers.

58. The ice cream according to claim 57, comprising 0.2-0.4 w/w %, such as 0.3 w/w % stabilizer.

59. The ice cream according to claim 45, wherein the fat in ice cream is, on weight basis, at least 50%, such as at least 60%, such as at least 75% and such as 100% vegetable fat.

60. The ice cream according to claim 59, wherein the vegetable fat is selected from the group consisting of palm fat, palm kernel fat, and coconut fat, or a combination thereof.

61. The ice cream according to claim 60, comprising at least one of palm kernel fat and coconut fat, wherein the ratio between palm kernel fat and coconut fat is 0:100-100:0, such as 20:80-80:20, such as 40:60-60:40, and such as 50:50.

62. The ice cream according to claim 45, comprising less than 0.5 w/w % stabilizers.

63. The ice cream according to claim 62, wherein the stabilizer is present in the range of 0.05-0.50, such as 0.10-0.40 and such as 0.15-0.25 w/w %.

64. The ice cream according to claim 45, comprising at least one stabilizer selected from the group consisting of guar, locust bean gum and carrageenan.

65. The ice cream according to claim 45, comprising 0.01-0.15% guar gum, such as 0.05-0.10 and 0.06-0.08 w/w % guar gum.

66. The ice cream according to claim 45, comprising 0.01-0.15% locust bean gum, such as 0.01-0.10 and 0.06-0.08 w/w % locust bean gum.

67. The ice cream according to claim 45, comprising 0.01-0.10% carrageenan, such as 0.02-0.07 and 0.03-0.06 w/w % carrageenan.

68. The ice cream according to claim 45, comprising 5-10% (w/w) of a hydrolyzed lactose preparation, 2-8% (w/w) sucrose and 10-22% (w/w) dextrose.

69. The ice cream according to claim 45, wherein the ice cream is packaged in a squeezable container.

70. The ice cream according to claim 45, wherein the ice cream is packaged in an aerosol.

71. An ice cream mix having a freezing point of −3.5° C. or lower, comprising at least 0.2% (w/w) unsaturated emulsifier.

72. The ice cream mix according to claim 71, comprising at least 0.25% (w/w) unsaturated emulsifier.

73. The ice cream mix according to claim 71, further comprising fat, milk solids non-fat, sugar and stabilizer.

74. The ice cream mix according to claim 71, having a freezing point of −4° C. or lower.

75. The ice cream mix according to claim 71, having a freezing point of −4.5° C. or lower.

76. A blend for preparing ice cream according to claim 45, comprising unsaturated emulsifier, fat, sugar, stabilizers and milk solids non-fat.

77. The blend according to claim 76, comprising 5-50% (w/w) unsaturated emulsifier, 5-60% (w/w) fat, 7-15% (w/w) sugar, 3-30% (w/w) stabilizers and 2-5% (w/w) milk solids non-fat.

78. The blend according to claim 77, comprising 7-40% (w/w) unsaturated emulsifier and 7-40% (w/w) fat.

79. The blend according to claim 78, comprising 10-35% (w/w) unsaturated emulsifier and 10-35% (w/w) fat.

80. The blend according to claim 76, comprising 5-22 w/w % stabilizers.

81. A process for the preparation of an ice cream according to claim 45, comprising the steps of:
a) preparing an ice cream mix having a freezing point of −3.5° C. or lower and comprising at least 0.2% (w/w) unsaturated emulsifiers;
b) aerating and freezing the mix at a drawing temperature in the range of −8° C. to −12° C.; and
c) hardening the ice cream at a temperature in the range of −20° C. to −50° C.

82. The process according to claim 81, wherein, in step a), the ice cream mix is prepared by combining a water phase and a fat phase, the emulsifier at least partially being incorporated in the fat phase.
